(19) United States
(12) Patent Application Publication
(10) Pub. No.: US 2005/0193060 A1
(43) Pub. Date: Sep. 1, 2005

(54) Sensor-enhanced document exchange and display control device

(76) Inventor: John J. Barton, Los Gatos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/788,868

(22) Filed: Feb. 26, 2004

(51) Int. Cl. G06F 15/16

(52) U.S. Cl. 709/204

(57) ABSTRACT

In one embodiment, the present invention recites a system for exchanging information. The system comprises a display unit and a document exchange unit communicatively coupled with the display unit. The document exchange unit further comprises a shared memory. A control unit is coupled with the document exchange unit and is used for selecting the information which is to be exchanged. The control unit transmits the selected information to the shared memory via the document exchange unit and the display unit thereafter displays the information. A sensor unit, which is communicatively coupled with the control unit, is used for accessing the information.

### TECHNICAL FIELD

Embodiments of the present invention are related to the field of display devices used in enhanced meeting environments.

### BACKGROUND ART

Enhanced meeting environments, also referred to as “interactive spaces,” are used to provide multimedia enhancement to meeting places such as conference rooms and classrooms. A typical interactive space may include speakers and microphones for capturing and amplifying speech and cameras for capturing events of the meeting. A digital projector is often used to display graphics and documents during a meeting. A computer containing the files that are displayed in the meeting must be coupled with the digital projector. Frequently, interactive spaces include support for wireless networking as well as supporting applications and middleware.

Display systems such as digital projectors are inconvenient for some users because a personal computer is used by a presenter(s) to project content that is viewed by other meeting participants. Typically, one participant of the meeting agrees to allow using their computer to control the digital projector. As a result, this computer is not available to the participant for private use during the meeting. Additionally, it is difficult for other meeting participants to access and exchange electronic copies of documents for viewing by the other meeting participants. Additionally, it is often difficult to work collaboratively on the displayed documents during the meeting and it is difficult to share or distribute electronic copies of the content to meeting participants for use after the meeting.

Another drawback is the expense of creating and maintaining a static infrastructure for an interactive space. Additionally, many users want to carry files for presentation on a more compact device than a laptop meetings and find it inconvenient to couple their computers ting environment.

### DISCLOSURE OF THE INVENTION

In one embodiment, the present invention recites a system for exchanging information. The system comprises a display unit and a document exchange unit communicatively coupled with the display unit. The document exchange unit further comprises a shared memory. A control unit is coupled with the document exchange unit and is used for selecting the information which is to be exchanged. The control unit transmits the selected information to the shared memory via the document exchange unit and the display unit thereafter displays the information. A sensor unit, which is communicatively coupled with the control unit, is used for accessing the information.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 shows components of an exemplary system for exchanging information in accordance with embodiments of the present invention.

FIG. 2 shows components of an exemplary system for exchanging information in accordance with another embodiment of the present invention.

FIG. 3 shows software components used in an exemplary system for exchanging information in accordance with embodiments of the present invention.

FIG. 4 is a flowchart of a method for exchanging information in accordance with embodiments of the present invention.

### MODES FOR CARRYING OUT THE INVENTION

Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

Embodiments of the present invention comprise a method and system for exchanging digital information, such as digital documents, during a meeting. In embodiments of the present invention, an electronic “document exchange” device is used to facilitate the exchange of digital documents. The document exchange device provides a shared temporary memory space for users to store electronic documents. The electronic documents stored in the temporary memory space can be accessed by other meeting participants and/or displayed during the meeting using a shared display device coupled with the document exchange device.

In embodiments of the present invention, users of a handheld “document control” device access and select electronic documents which may be exchanged in the meeting. Typically, the users of these document control devices are in the same meeting space such as a conference room or classroom. It is appreciated that the term “electronic document” may include electronic files comprising content other than text documents. That is, an electronic document may comprise audio, graphic, or other electronic content in accordance with embodiments of the present invention. The document control device can be coupled with a variety of sensors for accessing electronic documents. The users can then load selected documents into the shared memory of the document exchange device as well as view other documents in the shared memory using their document control device. The users can also download documents from the shared memory into a removable memory device coupled with the document control device, thus allowing users to carry a copy of an electronic document away from the meeting.

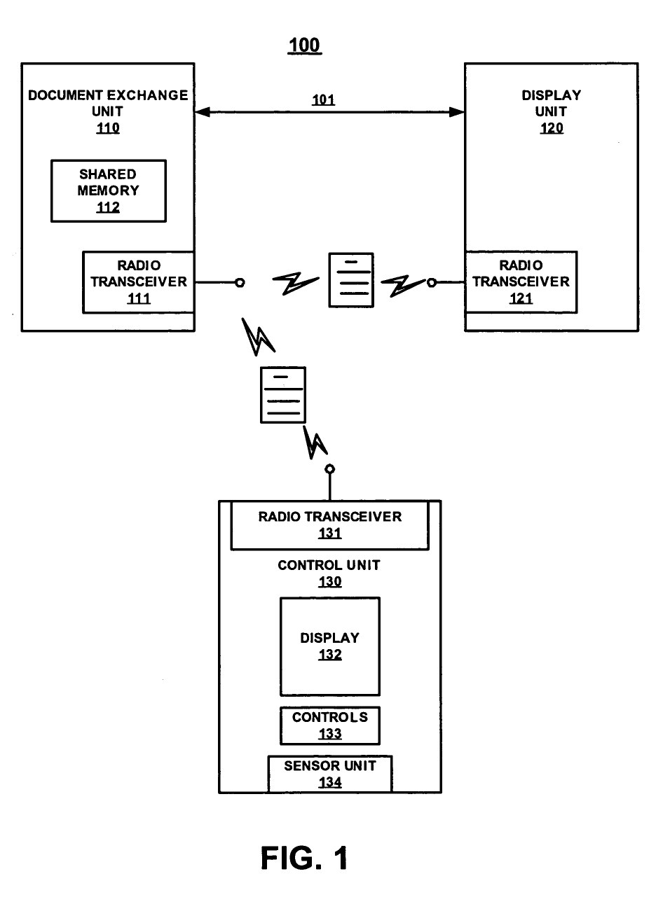

FIG. 1 shows components of an exemplary system 100 for exchanging information in accordance with embodiments of the present invention. In the embodiment of FIG. 1, a document exchange unit 110 is coupled with a display unit 120 via a coupling 101. In embodiments of the present invention, display unit 120 comprises a digital projector, a rear projection display, a Liquid Crystal Display (LCD) display, or another device for displaying information to a user. Coupling 101 may comprise a VGA cable, serial or parallel data connection, Ethernet interface, a Universal Serial Bus (USB) connection, a FireWire (IEEE 139) interface, a small computer system interface (SCSI), an infrared (IR) communication port, etc., in embodiments of the present invention. Display unit 120 comprises a shared display unit for meeting participants to view electronic documents.

Document exchange unit 110 and display unit 120 are also communicatively coupled via a wireless communications link between radio transceiver 111 of document exchange unit 110 and radio transceiver 121 of display unit 120. While the present embodiment recites radio transceivers, embodiments of the present invention are well suited to implement a variety of wireless communication devices such as Infrared communication ports, Bluetooth communications modules, cellular communications modules, or other IEEE 802.11 compliant devices.

In FIG. 1, document exchange unit 110 also comprises a shared memory 112. Shared memory 112 provides a shared space for users to exchange and access electronic copies of documents. The documents can then be displayed for the users using display unit 120. In one embodiment of the present invention, document exchange unit 110 and display unit 120 are part of a static infrastructure of an interactive space. In another embodiment, display unit 120 is a part of a static infrastructure and document exchange unit 110 comprises a portable device which can be communicatively coupled with display unit 120. In another embodiment, both document exchange unit 110 and display unit 120 are portable devices which can be brought into a meeting room to facilitate document sharing.

In FIG. 1, system 100 further comprises a control unit 130 which is used by users for accessing and exchanging electronic documents. In the embodiment of FIG. 1, control unit 130 comprises a radio transceiver 131, a display 132, controls 133, and a sensor unit 134. As described above with reference to document exchange unit 110 and display unit 120, a variety of wireless communications devices can be used to communicatively couple control unit 130 wit document exchange unit 110 in accordance with embodiments of the present invention.

In embodiments of the present invention, sensor unit 134 allows a user to access and/or exchange electronic documents with other meeting participants. In embodiments of the present invention, sensor unit 134 may comprise one or more sensors for accessing an electronic file from a variety of electronic media. For example, sensor unit 134 may comprise a port for accepting a removable memory device such as a CompactFlash card, a memory stick, a multimedia card, a secure digital (SD) card, a SmartMedia card, a Universal Serial Bus (USB) removable memory, a Personal Computer Memory Card International Association (PCMCIA) card, etc. Sensor unit 134 may comprise a device for reading optical storage devices (e.g., Digital Versatile Disks (DVDs), Compact Disks (CDs), or the like). In embodiments of the present invention, sensor unit 134 may also comprise a barcode reader, a device for reading radio frequency identification (RFID) tags, Infrared Data Association (IrDA) compliant memory devices. Sensor unit 134 may also comprise a port for coupling control unit 130 with a computer network (e.g., via an Ethernet interface) or with the Internet.

Using display 132 and controls 133, a user of control unit 130 can navigate a directory or hierarchy of files resident in a memory of control unit 130 using a graphical user interface of display 132. The directory of files may comprise a directory of files resident on a data storage device coupled with sensor 134 in accordance with embodiments of the present invention. A user can also select an electronic document stored on control unit 130 or on a data storage device coupled with sensor 134, preview it, and send it to the shared memory of document exchange unit 110. Additionally, a user of control unit 130 can navigate a directory of the documents stored on shared memory 112, access a selected document, and view it using display 132. Similarly, the user can store a copy of a document stored on shared memory 112 on a data storage device coupled with sensor 134.

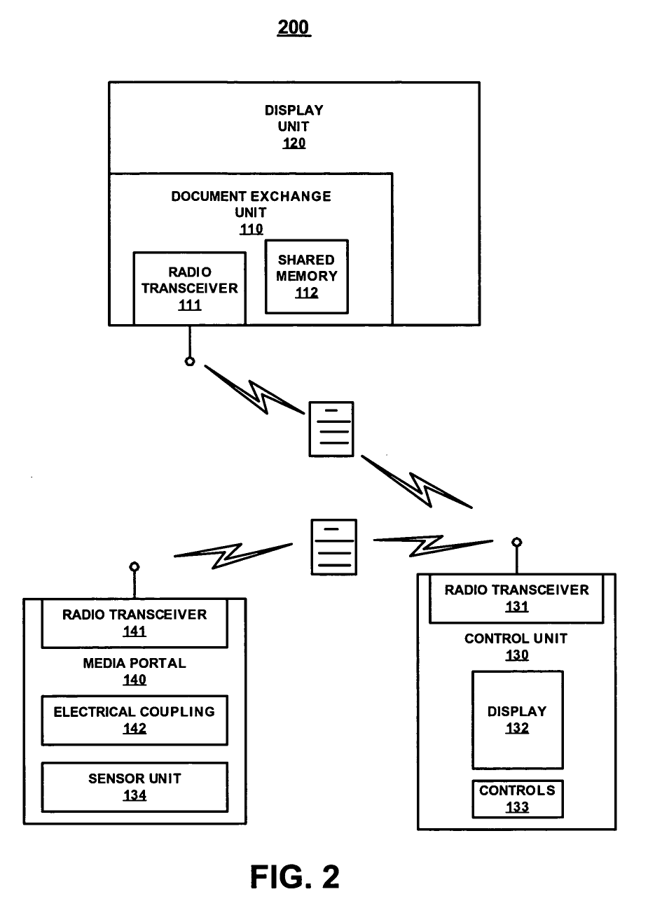

It is appreciated that some components (e.g., processors, memory devices, signal pathways, etc.) of document exchange unit 110, display unit 120 and control unit 130 have been omitted for clarity. Additionally, the functional components recited in system 100 may be combined in configurations other than that shown in FIG. 1. For example, FIG. 2 shows components of an exemplary system 200 for exchanging information in accordance with another embodiment of the present invention. In the embodiment of FIG. 2, document exchange unit 110 and display unit 120 are disposed in a common housing. That is, radio transceiver 111 and shared memory 112 are disposed in display unit 120. Electronic documents selected for exchanging by a user are sent directly from control unit 130 to display unit 120 using a communication link between radio transceivers 111 and 131.

Also shown in system 200 is a media portal 140. In embodiments of the present invention, media portal 140 is utilized in a manner similar to “docking stations” used to couple handheld electronic devices such as Personal Digital Assistants (PDAs) with personal computers. In the embodiment of FIG. 2, media portal 140 comprises a radio transceiver 141, an electrical coupling 142, and a sensor unit 134. Radio transceiver 141 and sensor unit 134 can be implemented in a manner similar to that described above with reference to FIG. 1. Electrical coupling 142 can be used to provide power to control unit 130 when media portal 140 and control unit 130 are coupled. Additionally, electrical coupling 142 can be used to charge a battery (not shown) disposed within control unit 130.

In the embodiment of FIG. 2, sensor unit 134 is disposed within media portal 140. When a data storage device is coupled with sensor unit 134, the directory of files, as well as the files themselves can be accessed by control unit 130 via a communicative coupling between radio transceivers 131 and 141. A user can then select and exchange documents in the manner described above with reference to FIG. 1. A user can also use control unit 130 to navigate documents stored in shared memory 112 and store a copy of a selected document from shared memory 112 upon a data storage device coupled with sensor unit 134.

In accordance with embodiments of the present invention, control unit 130 is a portable handheld device used by participants in a meeting. In the above described embodiments, control unit 130 is wirelessly coupled with other components in the system. However, in embodiments of the present invention, control unit 130 may be coupled with the other components in the system using data couplings such as an Ethernet coupling, a USB coupling, a FireWire coupling, or the like via media portal 140. Additionally, in embodiments of the present invention, control unit 130 may be another portable device (e.g., a laptop computer) capable of communicatively coupling with the other components of the system.

The following discussion is an exemplary description of a meeting in which documents are exchanged using systems 100 and 200 in accordance with embodiments of the present invention. Document exchange unit 110 and/or display unit 120 (e.g., a digital projector) are installed in a conference room as part of an enhanced media environment. In embodiments of the present invention, document exchange unit 110 may be an add-on component to display unit 120 to facilitate exchanging documents in accordance with embodiments of the present invention. Handheld control units 130 are coupled with recharging units (e.g., media portal 140 of FIG. 2) on the wall or upon a table in the conference room. Document exchange unit 110, display unit 120, and control unit 130 are communicatively coupled in a wireless local area network available to the conference room. Shared memory 112 of document exchange device 110 is made available to users via control units 130 which they are using. In other words, the users connect to the file system of shared memory 112 via the wireless local area network.

Meeting participants may bring electronic documents stored upon portable memory devices (e.g., SmartMedia cards, USB memory devices, CompactFlash, etc.) and couple them with sensor 134. The users of control unit 130 preview these documents using the controls 133 and display 132 of their respective control units 130 and select content for sharing. The control units 130 wirelessly transmit the selected documents to the document exchange unit 110 where they are stored in shared memory 112. Documents in shared memory are available to other meeting participants via their respective control units 130 and are displayed using display unit 120. Users may also bring RFID or barcode identifiers that point to on-line content such as websites. Upon reading the barcode or RFID tag, system 100, converts the data to a URL, connects with the Internet and accesses the content of the website. The RFID or barcode identifiers may also be embedded within documents brought into the conference room. As with other documents, users may preview remotely accessed documents before sending them to shared memory 112.

Using control unit 130, users can control cursors projected upon selected documents and may collaboratively edit the displayed document using, for example, the controls 133 of their respective control units 130. The users may also save copies of the electronic documents stored in the shared memory 112 to the data storage device coupled with sensor unit 134 of their respective control unit 130 or to another data storage device communicatively coupled with system 100. Upon completion of the meeting, participants can clear the shared memory 112 to prevent other users of the conference room from accessing sensitive material.

The present invention is advantageous over conventional conference systems in that it allows meeting participants to exchange documents without necessitating an expensive infrastructure. Document exchange unit can be coupled with existing display units such as digital projectors thus reducing the cost of implementing system 100. Additionally, less time is spent in setting up laptops and coupling them with the digital projector. Also, less time is spent in selecting a file system for sharing files between users and deciding how to connect to it. Instead, real time document sharing is facilitated using the control units 130.

As described above, meeting participants can bring media content (e.g., electronic documents) to the meeting in memory devices rather than in laptop computers. Additionally, the media content can be exchanged and copied by the meeting participants immediately. As a result, participation in discussions about the shared documents is facilitated. The privacy of the users is enhanced because they can preview the documents before exchanging them with other participants. Because entire documents are exchanged, animation and other effects used in presentations are supported rather than the projection of single images. Also, shared documents under discussion can be manipulated by other meeting participants and not just the document owner. Because meeting participants can access and share documents without necessarily disrupting the meeting, they can easily call up documents which are related to the documents under discussion.

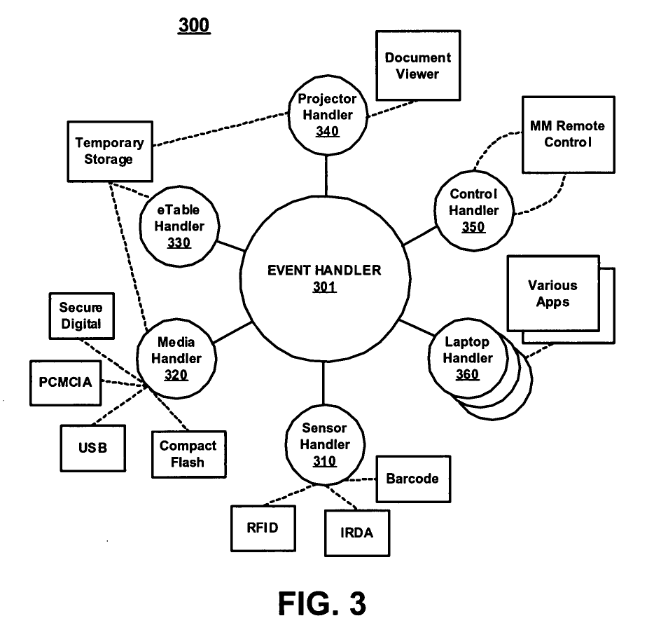

FIG. 3 shows an exemplary software system 300 for controlling an information exchange system in accordance with embodiments of the present invention. In embodiments of the present invention, system 300 is implemented by a document exchange unit (e.g., document exchange unit 110 of FIG. 1). Thus, in embodiments of the present invention, document exchange unit 110 performs as the central coordinating device in the system. However, in other embodiments of the present invention, system 300 may be implemented in a dedicated server. Event handler 301 allows document exchange unit 110 to host non-user-specific applications that are needed to support a temporary shared document space.

In one embodiment, system 300 comprises an event handler 301. In embodiments of the present invention, event handler 301 coordinates events among the various components of system 300 using TCP/IP connections. As a result, a control unit (e.g., control unit 130 of FIG. 1) can only participate in a meeting facilitated by document exchange unit 110 if it can communicate with event handler 301. Control units which have the client software installed automatically discover event handler 301 and establish an association with it. Control units which have not previously installed the client software may install it by accessing a downloadable version stored on, for example, document exchange unit 110 or a dedicated server with which the control unit is communicatively coupled.

Event handler 301 provides a library of APIs for a variety of languages that support TCP/IP sockets, and as a servlet that converts HTTP form submissions to event publications or subscription requests, thereby allowing devices that can run a Web browser to interact in a limited manner with event handler 301.

In embodiments of the present invention, event handler 301 supports multibrowsing. Multibrowsing aggregates all displays in an interactive space, whether on individual users' control units or on large shared displays (e.g., each display 132 and display unit 120). Meeting participants can “push” a document to any display or “pull” to their own control unit a document being shown on any display. This is accomplished via the event handler 301, the event handler servlet, and a simple browser plug-in. Additionally, event handler 301 supports sharing a pointer in the meeting space. In other words, any pointer in the shared space, whether a shared pointing device that is part of the infrastructure or the pointing devices on individual control units (e.g., 130) to range across all displays in the meeting space. This gives the illusion of a single pointer for the meeting space that can be controlled by any of the meeting participants. Event handler 301 allows multiple public displays to be aggregated for presenting slide presentations and other content, allows remote control of the presentation from any of the control units (e.g., 130) and enables meeting participants to “slave” their respective control unit 130 to the master presentation. Thus, the slide on each participant's control unit 130 advances to advances automatically whenever the presenter advances the slide on the main shared display (e.g., display unit 120).

In one embodiment of the present invention, sensor handler 310 and media handler 320 are disposed upon each of the control units 130 within the meeting space. Sensor handler 310 and media handler 320 send events to event handler 301.

Another component of system 300 is eTable handler 330. The eTable handler 330 coordinates access to the temporary storage area (e.g., temporary storage 331) of shared memory 112 which is accessed by the control units used by meeting participants to exchange documents. The eTable provides a public, sharable temporary storage and work space. The eTable is intentionally temporary so that meeting participants can erase this space when the meeting has ended. For example, in embodiments of the present invention, controls 133 comprises a clear button that erases temporary storage 331 when the meeting has ended. Functionally, the eTable is stored as a subdirectory in the files system of shared memory 112. Users view the eTable as a sub-tree in the user interface of display 132 of control unit 130. Mobile media and network content appear as other sub-trees in the user interface.

To place media into temporary storage 331, users may insert physical data storage devices into sensor unit 134, or use sensor unit 134 to read identifiers that point to the location of documents. The user then navigates, using controls 133, the directory displayed upon display 132 to find the desired document. The user selects a document using controls 133 and can preview the document before transmitting the document to temporary storage 331. Users can access and add content to documents in temporary storage 331 but cannot access the documents on other user's control units (e.g., control unit 130). Keeping content hidden from other meeting participants allows a user to privately browse content on the control unit 130 before choosing to move a selected document to the eTable. In addition to preserving the user's privacy, this also prevents the user from distracting other meeting participants during the selection process.

Alternatively, a user may encode a URL onto a RFID tag or a device upon which a barcode is printed. Sensor unit 134 can read the encoded pointer, contact an Internet service with the user's identification and receive a URL to the web page containing the desired information. In one embodiment of the present invention document exchange unit 110 accesses the desired web page which is then displayed by display unit 120. Similarly, a user can bind a document to a “blank” RFID card and carry the document out of the meeting. This allows meeting participants to bring electronic documents to a meeting using small physical objects like key chain, watches, identification badges or jewelry or using barcodes embedded on paper. As a result, papers, badges, maps, floor plans, musical scores, schedules, calendars, etc., can be tagged with IDs matching virtual resources related to that physical artifact. These “by-reference” URL links to online media provide an alternative path for input and output to the shared document space of temporary storage 331.

Event handler 301 communicates events between display unit 120 and control units 130 using projector handler 340 and control handler 350 respectively. In embodiments of the present invention, event handler supports other applications disposed, for example, upon a user's laptop computer or another computer using laptop handler 360.

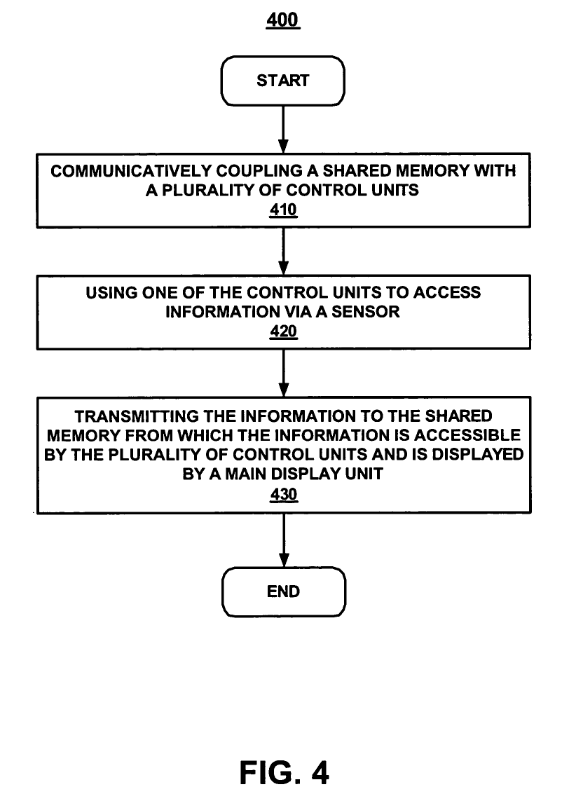

FIG. 4 is a flowchart of a method for exchanging information in. accordance with embodiments of the present invention. In step 410 of FIG. 4, a shared memory is communicatively coupled with a plurality of display units. As discussed above with reference to FIG. 3, temporary storage 331 is a shared memory area which is used for the temporary storage of documents which can be accessed by a plurality of control units (e.g., control unit 130 of FIG. 1).

In step 420 of FIG. 4, one of the plurality of control units is used to access information via a sensor unit. In embodiments of the present invention, each of the control units is communicatively coupled with a sensor unit. As discussed above with reference to FIG. 1, a sensor unit comprises one or more sensors for accessing data stored upon a data storage device. In embodiments of the present invention, removable data storage devices are used such as SmartMedia cards, CompactFlash cards, PCMCIA cards, USB memory devices, etc. Additionally, devices or documents having appended RFID or barcode pointers to a data location can be read by sensor unit 134 to access data.

In step 430 of FIG. 4, the information is transmitted to the shared memory from which the information is accessible by the plurality of control units and is displayed by a main display unit. In embodiments of the present invention, a control unit 130 is used to navigate the directory indicated by the sensor unit 134. A document can be selected and previewed by a user to determine if exchanging the document is desired. The user can then transmit the document to the shared memory area (e.g., temporary storage 331) to allow other users to access the document using their respective control units 130. Additionally, display unit 120 accesses the shared memory area and functions as a main display for the meeting by displaying a selected document for all of the meeting participants to view.

The preferred embodiment of the present invention, a sensor-enhanced document exchange and display control device, is thus described. While the present invention has been described in particular embodiments, it should be appreciated that the present invention should not be construed as limited by such embodiments, but rather construed according to the following claims.

1. A system for exchanging information, said system comprising:
a display unit;
a document exchange unit comprising a shared memory communicatively coupled with said display unit;
a control unit coupled with said document exchange unit, said control unit for selecting said information and for transmitting said information to said shared memory, and wherein said display unit thereafter displays said information; and
a sensor unit communicatively coupled with said control unit for accessing said information.

2. The system of claim 1 wherein said control unit is wirelessly coupled with said document exchange unit.

3. The system of claim 1 wherein said display unit, said document exchange unit and said shared memory are disposed in a common housing.

4. The system of claim 1 wherein said document exchange unit and said shared memory are wirelessly coupled with said display unit.

5. The system of claim 1 wherein said sensor unit comprises at least one input device selected from the group consisting of a removable memory input device, a barcode reader, a radio frequency identification (RFID) input device, an Infra-red Data Association (IrDA) input device, an optical media storage device drive, and a magnetic media storage device drive.

6. The system of claim 5 wherein said sensor unit further comprises a coupling for providing power to said control unit.

7. The system of claim 5 wherein said sensor unit and said control unit are disposed in a common housing.

8. The system of claim 1 wherein said control unit is further for selecting information stored in said shared memory and for receiving said information via said document exchange unit.

9. The system of claim 8 wherein said control unit stores said information in a data storage device coupled with said sensor unit.

10. A method for exchanging information comprising:
communicatively coupling a shared memory with a plurality of control units;
using one of said plurality of control units to access said information via a sensor; and
transmitting said information to said shared memory, wherein said information is accessible by said plurality of control units and wherein said information is displayed by a shared display unit.

11. The method as recited in claim 10 further comprising wirelessly coupling said control unit with a document exchange unit.

12. The method as recited in claim 10 wherein said main display unit, said document exchange unit and said shared memory are disposed in a common housing.

13. The method as recited in claim 10 further comprising wirelessly coupling said document exchange unit and said shared memory with said main display unit.

14. The method as recited in claim 10 wherein said sensor unit comprises at least one input device selected from the group consisting of a removable memory input device, a barcode reader, a radio frequency identification (RFID) input device, an Infra-red Data Association (IrDA) input device, an optical media storage device drive, and a magnetic media storage device drive.

15. The method as recited in claim 14 wherein said sensor unit further comprises a coupling for providing power to said control unit.

16. The method as recited in claim 14 wherein said sensor unit and said control unit are disposed in a common housing.

17. The method as recited in claim 10 further comprising:
using said control unit to select information stored in said shared memory; and
storing said information in a data storage device coupled with said sensor unit.

18. An information exchange system comprising:
means for sharing a temporary memory area wherein a document is accessible by a plurality of control units;
means for accessing said document, wherein said means for accessing is respectively coupled with each of said plurality of control units; and
means for conveying said document to said means for sharing using one of said plurality of control units, wherein said document is selected.

19. The information exchange system as recited in claim 18 wherein said means for accessing further comprises a means for storing a copy of a second document accessed via said means for sharing.

20. The information exchange system as recited in claim 18 wherein said means for conveying comprises means for wirelessly communicating with said means for sharing.
